(19) United States
(12) Patent Application Publication
(10) Pub. No.: US 2021/0325842 A1
(43) Pub. Date: Oct. 21, 2021

(54) PROCESS MONITORING DEVICE, PROCESS MONITORING METHOD, AND PROGRAM

(71) Applicants: Kabushiki Kaisha Toshiba, Tokyo (JP); Toshiba Infrastructure Systems & Solutions Corporation, Kawasaki-shi (JP)

(72) Inventors: Osamu YAMANAKA, Hachioji (JP); Yukio HIRAOKA, Inagi (JP)

(73) Assignees: Kabushiki Kaisha Toshiba, Tokyo (JP); Toshiba Infrastructure Systems & Solutions Corporation, Kawasaki-shi (JP)

(21) Appl. No.: 17/229,935

(22) Filed: Apr. 14, 2021

(30) Foreign Application Priority Data
Apr. 15, 2020 (JP) 2020-073109

(51) Int. Cl. G05B 19/05; G06F 17/16

(52) U.S. Cl. CPC G05B 19/058; G05B 2219/14006; G06F 17/16

(57) ABSTRACT

A process monitoring device includes a data collector, a statistic calculator and a comprehensive statistic calculator. The data collector acquires two or more variables indicating a state of a monitored target. The statistic calculator output each of the statistics that select two from the acquired variables. The comprehensive statistic calculator output a comprehensive statistic indicating a state of the monitored target based on a statistic output by the statistic calculator.

### CROSS-REFERENCE TO RELATED APPLICATIONS

This application is based upon and claims the benefit of priority from Japanese Patent Application No. 2020-073109, filed on Apr. 15, 2020, and the entire contents of which are incorporated herein by reference.

### FIELD

An embodiment described herein relates generally to a process monitoring device, a process monitoring method, and a program.

### BACKGROUND

In the related art, a technology has been devised to identify the state of the monitoring/diagnosis target process and provide the user with support information according to the state of the monitoring/diagnosis target process by analyzing data variables acquired by sensors, etc. from the process which is a target to be monitored/diagnosed using a method such as a multivariate statistical process control (MSPC).

FIG. 14 is a diagram showing an analysis method using a conventional MSPC.

As shown in FIG. 14, in the conventional technology, the diagnosis model has to be reconstructed when it was desired to exclude the data variables acquired by a specific sensor from the monitored/diagnosed target.

### DESCRIPTION OF THE DRAWINGS

FIG. 1 is a diagram showing a specific example of the configuration of the process monitoring device of the embodiment.

FIG. 2 is a diagram showing a specific example of the configuration of an anomaly diagnosis model automatic construction unit, an on-line anomaly monitoring/diagnosis unit, and a user interface unit in the process monitoring device of the embodiment.

FIG. 3 is a diagram showing a method of calculating a comprehensive statistic in the process monitoring device of the embodiment.

FIG. 4 is a diagram showing the idea and loading, and the concept of dispersion in the principal component direction of the bivariate Q statistic in the process monitoring device of the embodiment.

FIG. 5 is a diagram showing an example of a monitoring screen displayed on the display unit of the process monitoring device according to the embodiment.

FIG. 6 is a diagram showing an example of a monitoring screen displayed on the display unit of the process monitoring device according to the embodiment.

FIG. 7 is a diagram showing an example of a monitoring screen displayed on the display unit of the process monitoring device according to the embodiment.

FIG. 8 is a bar graph of a normalized bivariate Q statistic and a normalized univariate T\hat{ }2 statistic related to the variable X displayed on the display unit of the process monitoring device according to the embodiment.

FIG. 9 is a diagram showing the values of the bivariate Q statistic and the univariate T\hat{ }2 statistic together with the concentration display displayed on the display unit of the process monitoring device according to the embodiment.

FIG. 10 is a diagram showing a matrix scatter plot and a current value for a combination of two variables having a high correlation with the upper estimation factor displayed on the display unit of the process monitoring device according to the embodiment.

FIG. 11 is a diagram showing a configuration of a modification of the process monitoring device according to the embodiment.

FIG. 12 is a diagram showing a configuration of another modification of the process monitoring device according to the embodiment.

FIG. 13 is a diagram showing a configuration of still another modification of the process monitoring device according to the embodiment.

FIG. 14 is a diagram showing an analysis method by an MSPC in a conventional process monitoring device.

### DETAILED DESCRIPTION

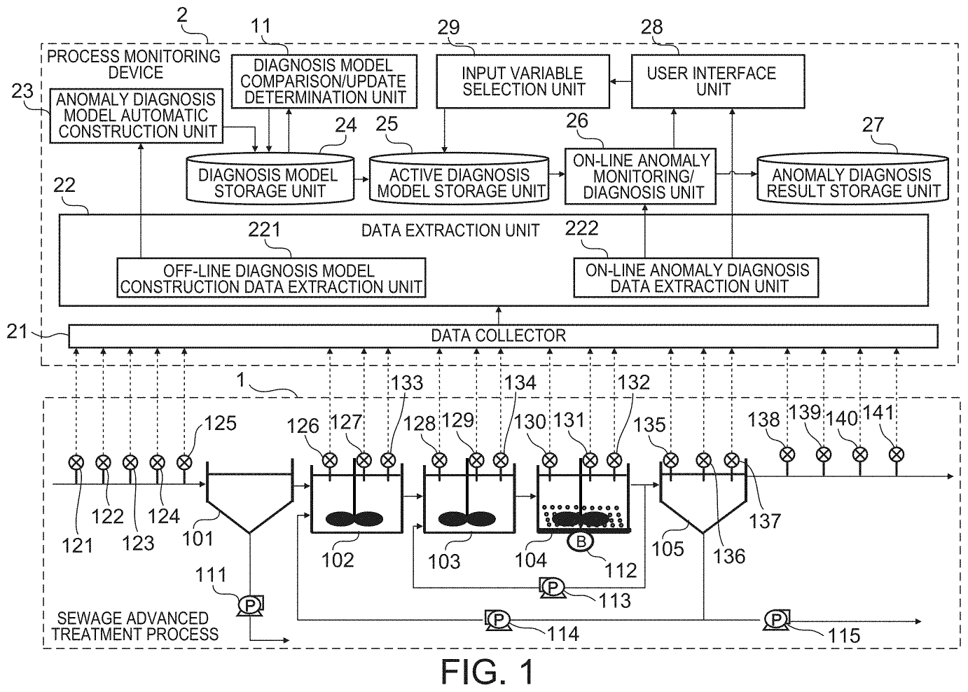

Hereinafter, the process monitoring device, the process monitoring method, and the program according to the embodiment will be described with reference to FIGS. 1 to 13.

In addition, “a_b” indicates that a small “b” is attached to the lower right of the letter “a”. Also, “a\hat{ }b” indicates that a small “b” is attached to the upper right of the letter “a”.

For example, “T\hat{ }2” indicates the letter shown in example A. “m_T_2” indicates the letter shown in example B.
T² - - - ex. A ₘT₂ - - - ex. B

FIG. 1 is a diagram showing a specific example of the configuration of a process monitoring device 2 of the embodiment. FIG. 1 shows a specific example in which the monitoring/diagnosis target of the process monitoring device 2 is a sewage advanced treatment process 1. In the embodiment, the target to be monitored/diagnosed is the sewage advanced treatment process 1, but the target to be monitored/diagnosed by the process monitoring device, the process monitoring method, and the program according to the embodiment may be any plant of a sewage treatment process, a wastewater treatment process, a sludge digestion process, a water purification process, a water supply and a distribution process, a chemical process, a steel process, a semiconductor manufacturing process, or the like. The sewage advanced treatment process 1 is a process aimed at removing nitrogen and phosphorus from sewage. The sewage advanced treatment process 1 includes a primary clarifier 101, an anaerobic basin 102, an anoxic basin 103, an aerobic basin 104, and a secondary clarifier 105. The sewage to be treated (hereinafter referred to as “water to be treated”) is sent to the primary clarifier 101, the anaerobic basin 102, the anoxic basin 103, the aerobic basin 104, and the secondary clarifier 105 in this order for treatment.

The primary clarifier 101 is a reservoir for the water to be treated that is sent to the sewage advanced treatment process 1. In the primary clarifier 101, solid matter having a heavy specific gravity is separated from the water to be treated by sedimentation.

The anaerobic basin 102 is a water tank for putting microorganisms that decompose organic substance into the water to be treated. In the anaerobic basin 102, the water to be treated is agitated in a state where no air is supplied. This causes the microorganisms to exhale phosphorus in the body. This process is generally called phosphorus discharge.

The anoxic basin 103 is a water tank for removing nitrogen from the water to be treated. Specifically, in the anoxic basin 103, the water to be treated returned from the aerobic basin 104 in the subsequent stage is mixed with the water to be treated sent from the anaerobic basin 102 and agitated in a state where no air is supplied. In the anoxic basin 103, nitric acid in the water to be treated is decomposed into nitrogen by the action of microorganisms and released into the atmosphere. This process is generally called denitrification.

The aerobic basin 104 is a water tank for decomposing organic substance in the water to be treated, removing phosphorus and nitrifying ammonia. Specifically, air is supplied to the water to be treated to activate the microorganisms, the microorganisms decompose organic substance, and the microorganisms absorb phosphorus in the water to be treated. Microorganisms that discharge phosphorus in an anaerobic state and accumulate organic substance absorb more phosphorus than they have discharged by being activated, so that phosphorus in the water to be treated is removed. Further, in the aerobic basin 104, ammonia is decomposed into nitric acid by supplying air to the water to be treated. This process is generally called nitrification.

The secondary clarifier 105 is a reservoir of water to be treated in which phosphorus has been removed and ammonia has been nitrified. In the secondary clarifier 105, the solid matter remaining in the water to be treated is separated by sedimentation, and the clear water of the supernatant is discharged as treated water.

An primary clarifier surplus sludge drawing pump 111 is a pump that draws and removes the settled sludge from the primary clarifier 101. The primary clarifier surplus sludge drawing pump 111 has a flow rate sensor that measures the flow rate of the drawn sludge.

A blower 112 is a blower that supplies oxygen to the aerobic basin 104. The blower 112 has a flow rate sensor that measures the flow rate of the supplied air.

A circulation pump 113 is a pump that returns the water to be treated from the aerobic basin 104 to the anoxic basin 103. The circulation pump 113 has a flow rate sensor that measures the flow rate of the returned water to be treated.

A return sludge pump 114 is a pump that draws part of the settled sludge from the secondary clarifier 105 and returns it to the anaerobic basin 102. The return sludge pump 114 has a flow rate sensor that measures the flow rate of the returned sludge.

A secondary clarifier surplus sludge drawing pump 115 is a pump that draws and removes the settled sludge from the secondary clarifier 105. The secondary clarifier surplus sludge drawing pump 115 has a flow rate sensor that measures the flow rate of the drawn sludge.

A rainfall sensor 121 is a sensor that measures the amount of rainfall in the vicinity of the sewage advanced treatment process 1. A sewage inflow sensor 122 is a sensor that measures the flow rate of sewage (hereinafter referred to as “inflow sewage”) flowing into the sewage advanced treatment process 1. An inflow TN sensor 123 is a sensor that measures the total amount of nitrogen (TN) contained in the inflow sewage. An inflow TP sensor 124 is a sensor that measures the total amount of phosphorus (TP) contained in the inflow sewage. An inflow organic substance sensor 125 is a UV (absorbance) sensor or a COD (chemical oxygen demand) sensor that measures the amount of organic substance contained in the inflow sewage.

An ORP sensor 126 is a sensor that measures the ORP (oxidation-reduction potential) in the anaerobic basin 102. An anaerobic basin pH sensor 127 is a sensor that measures the pH in the anaerobic basin 102. An anoxic basin ORP sensor 128 is a sensor that measures the ORP in the anoxic basin 103. An anoxic basin pH sensor 129 is a sensor that measures the pH in the anoxic basin 103. A phosphoric acid sensor 130 is a sensor that measures the phosphoric acid concentration in the aerobic basin 104. A DO sensor 131 is a sensor that measures the dissolved oxygen concentration (DO) in the aerobic basin 104. An ammonia sensor 132 is a sensor that measures the ammonia concentration in the aerobic basin 104. An MLSS sensor 133 is a sensor that measures the activated sludge concentration (MLSS) in at least one of the anaerobic basin 102, the anoxic basin 103, and the aerobic basin 104.

A water temperature sensor 134 is a sensor that measures the water temperature in at least one of the anoxic basin 103 and the aerobic basin 104. A surplus sludge SS sensor 135 is a sensor that measures the solid substance (SS) concentration of sludge drawn from the secondary clarifier 105. A discharge SS sensor 136 is a sensor that measures the SS concentration of the water discharged from the secondary clarifier 105. A sludge interface sensor 137 is a sensor that measures the sludge interface level of the secondary clarifier 105. A sewage discharge flow rate sensor 138 is a sensor that measures the flow rate of the discharged water. A discharged TN sensor 139 is a sensor that measures the total amount of nitrogen contained in the discharged water. A discharged TP sensor 140 is a sensor that measures the total amount of phosphorus contained in the discharged water. A discharged organic substance sensor 141 is a UV sensor or a COD sensor that measures the amount of organic substance contained in the discharged water.

Each of the above-mentioned devices such as the primary clarifier surplus sludge drawing pump 111, the blower 112, the circulation pump 113, the return sludge pump 114, and the secondary clarifier surplus sludge drawing pump 115 operates under the control of a predetermined cycle. Further, each of the above sensors including the flow rate sensor of each of the primary clarifier surplus sludge drawing pump 111, the blower 112, the circulation pump 113, the return sludge pump 114, and the secondary clarifier surplus sludge drawing pump 115 measures the sensing target at a predetermined cycle. Hereinafter, the flow rate sensors of the primary clarifier surplus sludge drawing pump 111, the blower 112, the circulation pump 113, the return sludge pump 114, and the secondary clarifier surplus sludge drawing pump 115 are collectively referred to as operation amount sensors, and other sensors are collectively referred to as process sensors. Each operation amount sensor and each process sensor transmit the measurement data obtained by sensing in a predetermined cycle to the process monitoring device 2 as process data.

Next, an embodiment of the process monitoring device 2 will be described.

The process monitoring device 2 includes a central processing unit (CPU), a memory, an auxiliary storage device, and the like connected by a bus, and executes a program. The process monitoring device 2 functions as a device including a data collection unit 21 (data collector), a data extraction unit 22, an anomaly diagnosis model automatic construction unit 23, a diagnosis model storage unit 24, an active diagnosis model storage unit 25, an on-line anomaly monitoring/diagnosis unit 26, and an anomaly diagnosis result storage unit 27, a user interface unit 28, and an input variable selection unit 29 by executing a program. All or part of each function of the process monitoring device 2 may be realized by using hardware such as an application specific integrated circuit (ASIC), a programmable logic device (PLD), or a field programmable gate array (FPGA). Further, the data collection unit 21 may be mounted as a device having a housing different from that of the process monitoring device 2 by using a programmable logic controller (PLC). The program may be recorded on a computer-readable recording medium. A computer-readable recording medium is, for example, a portable medium such as a flexible disk, a magneto-optical disk, a ROM, or a CD-ROM, or a storage device such as a hard disk built in a computer system. The program may be transmitted through a telecommunication line.

The data collection unit 21 (data collector) acquires and records two or more pieces of process data, which are variables indicating the state of the monitored target from each operation amount sensor and each process sensor. The acquired process data is output to the data extraction unit 22. The acquired process data is time series data of each process variable indicating the state of the process to be monitored. The data collection unit 21 records the acquired process data according to a predetermined format. The data collection unit 21 has a storage device (not shown) such as a magnetic hard disk device or a semiconductor storage device. The data collection unit 21 stores the acquired process data. In the embodiment, this step is referred to as a data collection step.

The data extraction unit 22 includes an off-line diagnosis model construction data extraction unit 221 and an on-line anomaly diagnosis data extraction unit 222. The off-line diagnosis model construction data extraction unit 221 extracts, as data for a diagnosis model construction, data for a predetermined period acquired from various process sensors by a predetermined cycle or an external request from the data collection unit 21. The on-line anomaly diagnosis data extraction unit 222 extracts process data by various process sensors required for on-line anomaly diagnosis in real time at a predetermined cycle.

The anomaly diagnosis model automatic construction unit 23 uses the data of all variables (hereinafter, all variables) collected by various process sensors for a predetermined period extracted by the off-line diagnosis model construction data extraction unit 221 to construct an anomaly diagnosis model by the method described later.

The diagnosis model storage unit 24 stores the diagnosis model constructed by the anomaly diagnosis model automatic construction unit 23.

The active diagnosis model storage unit 25 extracts and stores a diagnosis model actually used (hereinafter referred to as an active diagnosis model) from among the diagnosis models stored in the diagnosis model storage unit 24 by a predetermined determination.

The on-line anomaly monitoring/diagnosis unit 26 performs, in a predetermined monitoring cycle, an anomaly diagnosis in real time using the diagnosis model of the active diagnosis model storage unit 25 and the anomaly diagnosis data extracted by the on-line anomaly diagnosis data extraction unit 222.

The anomaly diagnosis result storage unit 27 stores, as time series data, the history of the anomaly diagnosis results diagnosed by the on-line anomaly monitoring/diagnosis unit 26.

The user interface unit 28 presents the anomaly diagnosis result diagnosed by the on-line anomaly monitoring/diagnosis unit 26 to the plant administrator and the operator through the user interface in real time.

The input variable selection unit 29 selects and changes, based on the anomaly diagnosis result monitored through the user interface unit 28, the input variables to be used for diagnosis from all the variables measured through various process sensors by the plant administrator and the operator who are users to store the result in the active diagnosis model storage unit 25.

A diagnosis model comparison/update determination unit 11 compares the diagnosis models periodically generated by the anomaly diagnosis model automatic construction unit 23, and periodically stored in the diagnosis model storage unit 24 to adopt a diagnosis model to be used for on-line diagnosis.

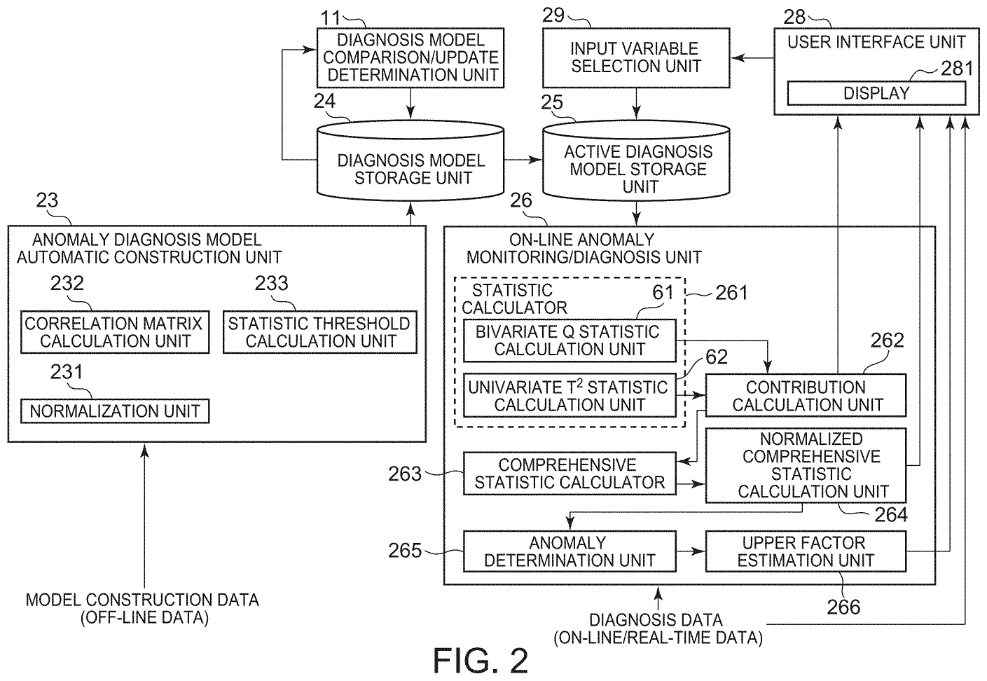

FIG. 2 is a diagram showing details of the configurations of the anomaly diagnosis model automatic construction unit 23, the on-line anomaly monitoring/diagnosis unit 26, and the user interface unit in the process monitoring device 2 of the embodiment. The anomaly diagnosis model automatic construction unit 23 includes a normalization unit 231, a correlation matrix calculation unit 232, and a statistic threshold calculation unit 233 (statistic threshold calculation section). The on-line anomaly monitoring/diagnosis unit 26 includes a statistic calculation unit 261 (statistic calculator), a contribution calculation unit 262, a comprehensive statistic calculation unit 263 (comprehensive statistic calculator), a normalized comprehensive statistic calculation unit 264, an anomaly determination unit 265, and an upper factor estimation unit 266. The user interface unit 28 includes a display unit 281 (display).

The normalization unit 231 of the anomaly diagnosis model automatic construction unit 23 normalizes the data for each variable of all variables measured and collected by various process sensors extracted from the off-line diagnosis model construction data extraction unit 221 in the data extraction unit 22. The correlation matrix calculation unit 232 uses the data normalized by the normalization unit 231 to generate a so-called correlation matrix consisting of the correlation coefficient of the combination of all the two variables extracted from all the variables. The statistic threshold calculation unit 233 uses the correlation matrix calculated by the correlation matrix calculation unit 232 to determine the anomaly detection thresholds such as the comprehensive statistic, the bivariate Q statistic (two-variable Q statistic) and the univariate T\hat{ }2 statistic (one-variable T\hat{ }2 statistic), described later and used for the anomaly detection. The anomaly diagnosis model automatic construction unit 23 periodically operates in a predetermined cycle TH≤TM. The comprehensive statistic may be referred as total statistic, synthesis statistic, integration statistic or composite statistic. In addition, the word “monitored target” may be referred as monitored object. The word “state” may be referred as status or condition.

The statistic calculation unit 261 (statistic calculator) of the on-line anomaly monitoring/diagnosis unit 26 includes a bivariate Q statistic calculation unit 61 and a univariate T\hat{ }2 statistic calculation unit 62. The bivariate Q statistic calculation unit 61 calculates each Q statistic used by the MSPC for all combinations in which two are selected from real-time data of all variables acquired by the data collection unit 21, and extracted by the on-line anomaly diagnosis data extraction unit 222 of the data extraction unit 22. The univariate T\hat{ }2 statistic calculation unit 62 uses the real-time data of all variables extracted by the on-line anomaly diagnosis data extraction unit 222 to calculate the T\hat{ }2 statistic used by the MSPC or the SPC for each variable of all variables. Outputting either or both of the Q statistic and the T\hat{ }2 statistic by the statistic calculation unit 261 is referred to as a statistic calculation step. The contribution calculation unit 262 synthesizes the bivariate Q statistic calculated by the bivariate Q statistic calculation unit 61 and the univariate T\hat{ }2 statistic calculated by the univariate T\hat{ }2 statistic calculation unit 62 to define the contribution of each variable to the comprehensive statistic described later for all variables. The comprehensive statistic calculation unit 263 synthesizes, based on the statistic output by the statistic calculation unit 261, the contribution of each variable calculated in the contribution calculation unit 262 to calculate a comprehensive statistic that represents the state of the monitored target and the comprehensive degree of abnormality. The step in which the comprehensive statistic is calculated by the comprehensive statistic calculation unit 263 is referred to as a comprehensive statistic calculation step. The normalized comprehensive statistic calculation unit 264 normalizes the anomaly determination threshold of the comprehensive statistic to one by dividing the comprehensive statistic calculated by the comprehensive statistic calculation unit 263 by the threshold calculated by the statistic threshold calculation unit 233. The anomaly determination unit 265 determines an anomaly based on the normalized anomaly determination threshold of 1 (one) for the normalized comprehensive statistic calculated by the normalized comprehensive statistic calculation unit 264. When the anomaly determination unit 265 determines that it is abnormal, the upper factor estimation unit 266 estimates the variable of the upper factor that is the factor and the combination of two variables among all the variables that are the factors.

The display unit 281 (display) of the user interface unit 28 displays the diagnosis data (on-line/real-time data), and the contribution, the normalized comprehensive statistic, the variable of the upper factor and the combination of the two variables among all the variables that are the factors, output by the on-line anomaly monitoring/diagnosis unit 26.

Next, the action of the process monitoring device 2 will be described.

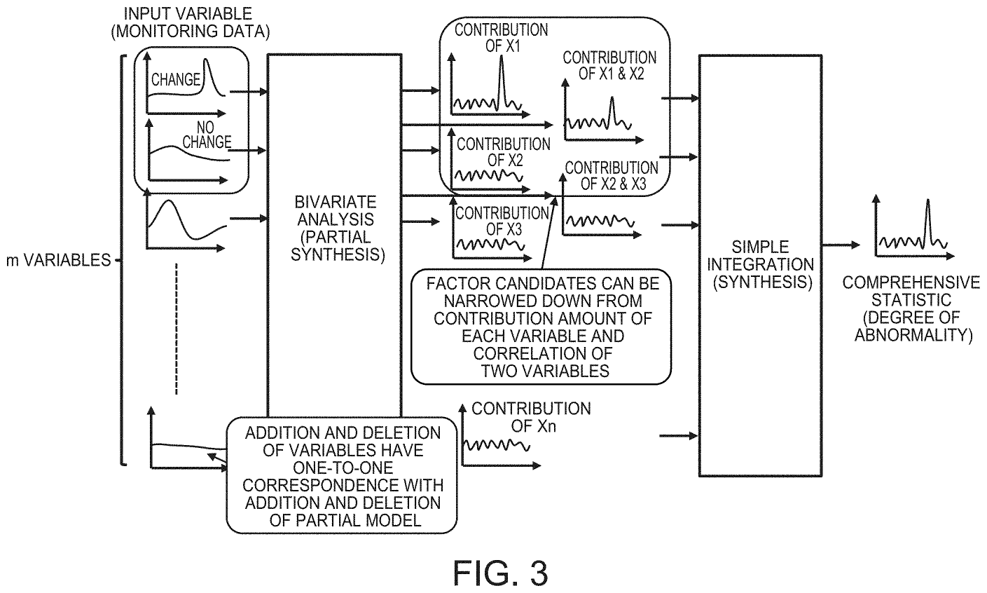

FIG. 3 is a diagram showing a method of calculating the comprehensive statistic in the process monitoring device 2 of the embodiment. First, in the sewage advanced treatment process 1, process information is measured at a predetermined cycle by the operation amount sensor and various process sensors. The measurement information is stored as time series data by the data collection unit 21 according to a predetermined format.

The off-line diagnosis model construction data extraction unit 221 of the data extraction unit 22 acquires, as time series data for a predetermined period specified separately, the data of the items corresponding to the operation amount sensor and the various process sensors to be used in the anomaly diagnosis model automatic construction unit 23 at a predetermined cycle TL. As an example, a predetermined cycle TM=one day and a predetermined period L=seven days (one week) are specified. When this data is specified to be acquired at 0:00, for example, the data for the past one week will be periodically extracted at 0:00 every day. The data set extracted in this way will be described as Zk, where k=1, k is an index when the data collected in the cycle TM is disposed in chronological order, and the first day of the start of diagnosis model construction corresponds to k=1 and the second day corresponds to k=2. The Zk is a matrix with the number of variables in the column direction and the time (sample=time series data) in the row direction. In the case of the embodiment, in the matrix, 26 variables, including five variables measured by the operation amount sensor and 21 variables measured by the process sensor, correspond to the number of columns, and when the measurement cycle of the on-line sensor is, for example, one minute, 60×24×7 corresponds to the number of rows. The number of rows is n (=60×24×7) and the number of columns is m (=26). In the following, when it is not necessary to be particularly conscious of the date when the diagnosis model is constructed, it is simply described as Z and the subscript k is omitted. The off-line diagnosis model construction data extraction unit 221 extracts this Z at a predetermined cycle.

In addition, in the target process of the embodiment, m=26, but the actual sewage treatment facility that is medium-sized or larger often includes a plurality of water treatment lines (for medium-sized and larger processing plants, water treatment is often performed in parallel like a pool course (lane), and the water treatment corresponding to each course is referred to as a “line”, and often named as first line, second line, . . . ), so that for example, m=26×10=260 variables when there are ten lines in a large-scale processing plant. In addition, in plants (power plants, petrochemical plants, etc.) other than water treatment, it is not uncommon to have hundreds to thousands of variables, and in the embodiment, it is especially effective in the case of such “multivariate”.

Next, the anomaly diagnosis model automatic construction unit 23 constructs, using Z, a diagnosis model for anomaly diagnosis using the concept of synthesizing anomaly detection data called the Q statistic and the T\hat{ }2 statistic by the multivariate statistical process control (MSPC) using a principal component analysis (PCA), which is a multivariate analysis method. The difference from the conventional MSPC is that it is not applied to all m variables, but to all combinations of two variables.

First, before applying the PCA to obtain the Q statistic, the column vector of Z is normalized by the following transformation because the time series data of each variable corresponds to the column vector of Z.

[Equation 1]

xᵢ=(zᵢ−μᵢ)/σi, i=1,2, . . . ,m (1)

zi is the column vector of Z, where Z=[z1, z2, . . . , and zm], and μi and of are the location parameter and scale parameter of zi, respectively, and are typically the average and the standard deviation, respectively. However, it is also possible to use the median as the location parameter and the median absolute deviation (MAD) as the scale parameter, assuming that abnormal data is included. Further, the pruning average or pruning standard deviation for obtaining the average or standard deviation by removing a certain percentage of data may be used. The operation according to Equation (1) is the operation of the normalization unit 231. In addition, since pi and of are used when the diagnosis model comparison/update determination unit 11, compares models, it is preferable to vectorize each variable and hold it, and the location parameter (center value) vector μ and the scale parameter (scale value) vector σ are defined as follows.

[Equation 2]

μ=[μ1,μ2,μ3 . . . ,μm]^{T} (2)

[Equation 3]

σ=[σ1,σ2,σ3 . . . ,σm]^{T} (2)

μ is the location parameter vector and σ is the scale parameter vector, each of which has m elements of the variable. This is the action of the normalization unit 231.

Next, the bivariate Q statistic is obtained using the normalized data X shown in Equation (1). At this time, as in the normal MSPC, a matrix P called the loading matrix defined by PCA and the variance Λ of each principal component axis defined using the loading matrix are obtained using the principal component analysis (PCA). By either method, a correlation matrix consisting of elements corresponding to the correlation coefficients of two variables of all m_C_2 combinations is generated, and is set to a diagnosis model. This is the action of the correlation matrix calculation unit 232.

Next, the statistic threshold calculation unit 233 calculates the thresholds for the bivariate Q statistic and the univariate T\hat{ }2 statistic, and the threshold for the comprehensive statistic to be synthesized from these statistics.

Since the bivariate Q statistic and the univariate T\hat{ }2 statistic are the thresholds for the Q statistic and the T\hat{ }2 statistic of m≥1 variable, respectively, the reliability limit value of each statistic used in a normal MSPC can be set as a typical threshold setting method, (Non Patent Literature by C. Rosen “Monitoring Wastewater Treatment Systems”, Lic. Thesis, Dept. of Industrial Electrical Engineering and Automation, Lund University, Lund, Sweden (1998)).

Specifically, this can be written as follows. Qlimit theoretical formula (for 2 variables):

[Equation 4]

Qlimit=θ₁[(c_{α}(2θ₂h₀²)^{1/2})/θ₁+1+(θ₂h₀(h−1))/(θ₁²)]^{1/h}₀

h₀:=1−2θ₁θ₃/3θ₂²

θi:=λ₂ⁱ (4)

cα is the deviation of the standard deviation of the standard normal distribution when the limit of the confidence interval is 1−α (for example, 2.53 when α=0.01 and 1.96 when α=0.05). λ2 is the second diagonal element of Λ (dispersion in the second principal component direction). That is, Θi is the sum of i-th powers of the components of the error term (second principal component). T\hat{ }2limit theoretical formula (for one variable):

[Equation 5]

T²limit=F(1,n−1,α) (5)

n is the total number of pieces of data. F(1, n−1, α) is an F distribution when the number of degrees of freedom is (1, n−1) and the reliability limit is a (often set to 0.01 or 0.05).

In this way, the thresholds for the bivariate Q statistic and the univariate T\hat{ }2 statistic can be calculated by Equation (4) and Equation (5), but this threshold calculation can be simplified by setting the variables to be handled to be bivariate (or below), and in principle, there is no need to set two thresholds. Specifically, Equation (4) is an approximate expression derived for the purpose of correcting the difference in variance in each principal component direction that stretches the residual space when the residual space is multidimensional (two or more dimensions). Since the dimension of the residual space is inevitably one dimension in the bivariate Q statistic, no correction is required. Furthermore, the normalization process with (one-dimensional) variance essentially eliminates the difference between the Q statistic and the T\hat{ }2 statistic. This will be described below. In order to define the Q statistic in the case of two variables, it is necessary to always set the second principal component direction as the residual space of the Q statistic. This is because the residual space cannot be defined unless the first principal component direction is included in the space representing the (two-variable) T\hat{ }2 statistic, and when the space that combines the first and second principal components is a space that defines the (two-variable) T\hat{ }2 statistic, there is no space that is a “residual”, so that the Q statistic cannot be defined.

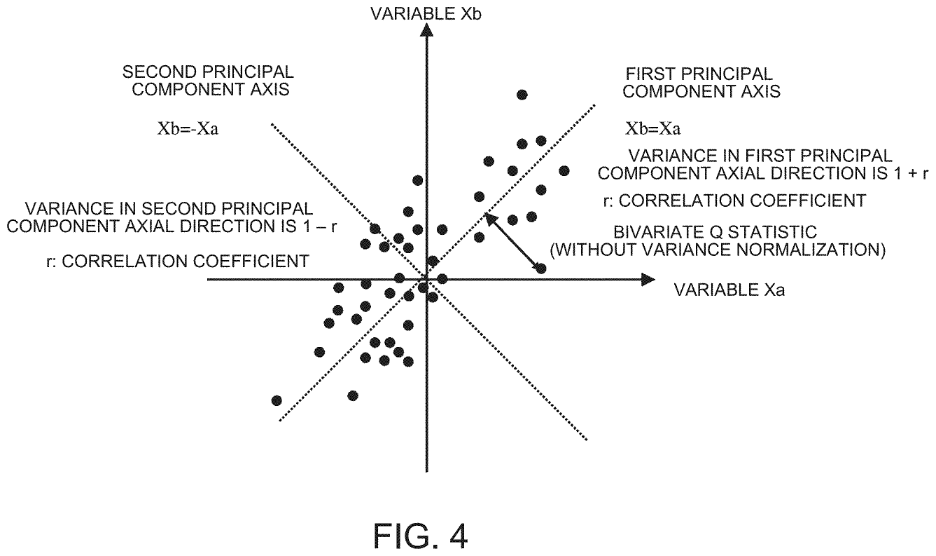

FIG. 4 is a diagram showing the idea and loading, and the concept of dispersion in the principal component direction of the bivariate Q statistic in the process monitoring device 2 of the embodiment.

With this in mind, it is possible to normalize the Q statistic with the variance in the second principal component direction, and when the Q statistic is normalized by the variance in the second principal component direction in this way, it is the same as considering the T\hat{ }2 statistic for the second principal component direction. Therefore, when the value obtained by normalizing the two-variable Q statistic by the variance λ2i in the second principal component direction is newly defined as the Q statistic, the threshold for this new Q statistic can be given by the reliability limit of the F distribution expressed by Equation (5). In other words, the thresholds for the bivariate Q statistic and the univariate T\hat{ }2 statistic can be calculated by Equation (5).

This fact has a great practical merit not only in that thresholds can be set with a common indicator, but also in that when setting the threshold, parameters required are only two parameters, the reliability limit α and the number of data points n used for it. That is, in general, the threshold for the Q statistic changes significantly when the diagnosis model is changed, because the theoretical threshold as represented by Equation (4) is affected by the dispersion in the principal component direction, which is a parameter of the diagnosis model. Looking at this from another point of view, it means that in the value of the Q statistic, its typical value itself changes greatly depending on the diagnosis model. On the other hand, since Equation (5) used in the T\hat{ }2 statistic does not include a model parameter, the threshold depends only on the reliability limit α set by the designer and the number of data points n used. This means that the T\hat{ }2 statistic is not a quantity that changes significantly depending on the diagnosis model, and is easier to handle than the Q statistic from the viewpoint of plant monitoring. The reason for this difference is that while the T\hat{ }2 statistic is “a quantity normalized by the variance of the space in which the data is distributed”, the Q statistic is “an index showing the deviation from the space where the data is distributed”. Although it is possible in principle to define the T\hat{ }2 statistic for the residual space remaining in the space where the data is distributed, the meaning of “correlation break” or “deviation from the data distribution space” of the Q statistic changes slightly, so that in the conventional MSPC, the Q statistic is defined and used for the residual space. However, for the bivariate Q statistic, the residual space can only be a one-dimensional space in the second principal component direction, and the second principal component direction is set to the only one direction regardless of the data used (in the case of positive correlation, the axial direction of Xa=−Xb, and in the case of negative correlation, the axial direction of Xa=Xb), so that the Q statistic (=the T\hat{ }2 statistic in the residual space) normalized by the variance in the second principal component direction mentioned above has exactly the same meaning as the original Q statistic with just a difference in scaling. For this reason, using the Q statistic normalized by the variance in the second principal component direction eliminates the need to distinguish between the Q statistic and the T\hat{ }2 statistic, and the threshold can be determined by Equation (5), in which it can be determined simply by the parameters a and n, which do not depend on the diagnosis model. Furthermore, in Equation (5), since it is known in the field of statistics that the F distribution with (1, n−1) degrees of freedom and the chi-squared distribution with one degree of freedom are almost the same when the number of data points n is large enough, Equation (5) may be considered as Equation (6) when the diagnosis model is constructed with a sufficient number of pieces of data.

[Equation 6]

T²limit=χ²(1,α) (6)

This fact is important. It means that the anomaly determination thresholds for the univariate T\hat{ }2 statistic and the (modified) bivariate Q statistic are determined simply by the reliability limit value α set by the designer when the diagnosis model is constructed using a sufficient number of pieces of data, and from the viewpoint of handling the diagnosis model, it has an extremely useful property in that it is possible to greatly reduce the complexity of setting the threshold.

Looking at this fact from another point of view, the threshold setting can be further simplified. In the field of statistics, it is known that the reliability limit value α of the F distribution with (1, n−1) degrees of freedom in Equation (5) is the square of the reliability limit value α of the t distribution with (n−1) degrees of freedom. This is a special relationship that holds only when the number of first degrees of freedom of the F distribution is one, and when the number of degrees of freedom is one, the statistic that follows the F distribution means that it is the square of the statistic that follows the t distribution. On the other hand, it is known that in the t distribution with n−1 degrees of freedom, when n is sufficiently large (that is, the amount of data is sufficient), the t distribution can be approximated by a normal distribution. Furthermore, it is known that the squared statistic of a statistic (random variable) that follows a normal distribution follows a chi-squared distribution with one degree of freedom. That is, in the F distribution, the fact that the number of first degrees of freedom is one and the number of second degrees of freedom is large enough means that the number of essential variables is one and there is a sufficient amount of data, and the statistic that follows such a distribution can be treated as a squared statistic of a normal distribution (that is, the squared statistic of the statistic following the t distribution with n−1 degrees of freedom=the statistic following the F distribution with (1, n−1) degrees of freedom→the squared statistic of the statistic following the normal distribution=the chi-squared statistic with one degree of freedom as n−1→infinity). From this point of view, the thresholds for the bivariate Q statistic and the univariate T\hat{ }2 statistic can be applied as they are to the threshold setting based on the σ value used in the SPC concept. In other words, in the SPC, in many cases, a normal distribution is assumed, and the value of K times the standard deviation is set as the threshold reference where K is set to about K=2 to 3, but the threshold represented by Equation (6) can be set at about 4 to 9 without specifically setting the reliability limit value α. In other words, since it is widely known in the SPC that 2σ at K=2 corresponds to 1−α=about 95%, and 3σ at K=3 corresponds to 1−α=about 99.7%, for example, setting α=1−0.997 to calculate Equation (6) and forcibly setting T2lim=9 are the same. Therefore, even when the reliability limit α is not explicitly set, it is possible to immediately calculate 3\hat{ }2=9 when the threshold corresponds to about 3σ. This is not only an advantage in the sense that it eliminates the need for calculation, but also important to intuitively understand how large a value the univariate T\hat{ }2 statistic and the bivariate Q statistic have.

Using the above idea, the thresholds for the bivariate Q statistic and the univariate T\hat{ }2 statistic can be easily determined.

Next, it is necessary to determine the threshold of the comprehensive statistic to be synthesized from these statistics, which will be described later. As will be described later, there is a plurality of ways to decide the comprehensive statistic. When the comprehensive statistic is the sum of the two-variable Q statistic and the one-variable T\hat{ }2 statistic, the threshold can be determined based on the following idea (when another definition method is used, the threshold setting method of Equation (5) or Equation (6) can be used directly).

When the comprehensive statistic is the sum of the two-variable Q statistic and the one-variable T\hat{ }2 statistic, each of these elements follows the F distribution with (1, n−1) degrees of freedom as described above, and it follows approximately the chi-squared distribution with one degree of freedom, so that the sum of the total m+m_C_2 statistics of the m_C_2 two-variable Q statistics and the m one-variable T\hat{ }2 statistics can be considered to approximately follow the chi-squared distribution with m+m_C_2 degrees of freedom. Therefore, the threshold of the comprehensive statistic can be obtained by the following Equation (7).

[Equation 7]

Slimit=χ²(m+ₘC₂,α) (7)

Slimit is the threshold for the comprehensive statistic. However, Equation (7) holds approximately when the m+m_C_2 bivariate Q statistics and univariate T\hat{ }2 statistics in total are independent of each other. When they are correlated with each other, Equation (7) may not hold even approximately. In such a case, the diagnosis is performed more accurately, for example, when the principal component analysis PCA is applied to the m+m_C_2 bivariate Q statistics and univariate T\hat{ }2 statistics, and the number of variables (the number of independent variables) until the cumulative contribution exceeds the threshold set at about 90° to 99° is set as the degree of freedom.

In any case, when the degree of freedom and the reliability limit are given, the threshold of the comprehensive statistic can be calculated by Equation (7). The point to note here is that when the number of combinations of input variables is changed from m to p (p≤m), the threshold can be corrected simply by resetting the degree of freedom by changing the number of degrees of freedom in Equation (7) from m+m_C_2 to p+p_C_2, or recalculating the degree of freedom using principal component analysis to perform calculation. In addition, when m is large enough to increase or decrease some variables, the value of m+m_C_2 is large enough (for example, 5050 for m=100), and it is unlikely that the number of components of independent variables calculated by the PCA will fluctuate significantly, so that there is almost no need to update Equation (7) for changes in some input variable combinations.

By the above processing, the thresholds for the bivariate Q statistic, the univariate T\hat{ }2 statistic, and the comprehensive statistic can be set. This is the action of the statistic threshold calculation unit 233.

As described above, the action of the anomaly diagnosis model automatic construction unit 23 is completed by normalizing the data, generating the correlation matrix, and generating the threshold. It should be noted that this function is executed at a predetermined cycle such as TM=1 day.

The diagnosis model generated by the anomaly diagnosis model automatic construction unit 23 executed in a predetermined cycle is stored in the diagnosis model storage unit 24. For example, when set at TM=1 day, a diagnosis model is constructed every day and stored in the active diagnosis model storage unit 25 in a predetermined format.

Next, a diagnosis model comparison/update determination unit 11 compares the diagnosis models periodically generated by the anomaly diagnosis model automatic construction unit 23, and periodically stored in the diagnosis model storage unit 24 to adopt a diagnosis model to be used for on-line diagnosis. The models are compared for the location parameter vector and scale parameter vector, and the correlation coefficient, which is an element of the correlation matrix, of Equation (2) and Equation (3).

The diagnosis model comparison/update determination unit 11 compares the diagnosis models stored in the diagnosis model storage unit 24 to, finally, store the diagnosis model to be applied to the active diagnosis model storage unit 25. This is usually carried out in a cycle of TL>TM. For example, when set at TL=2 weeks, the model will be updated (including non-update determination) every weeks. This is the action of the diagnosis model comparison/update determination unit 11.

Next, the on-line anomaly monitoring/diagnosis unit 26 performs the on-line anomaly diagnosis using the diagnosis model stored in the active diagnosis model storage unit 25. This action will be described below.

First, real-time data of all variables is extracted from the on-line anomaly diagnosis data extraction unit 222 at a predetermined cycle TH. For example, when set at TH=5 minutes, real-time data of all variables is captured in a 5-minute cycle.

The captured data is pre-normalized using Equation (1) and Equation (2). Let this be x (t).

Next, the bivariate Q statistic calculation unit 61 calculates the m_C_2 bivariate Q statistics. The formula for calculating the Q statistic is generally given by Equation (8). Q statistic:

[Equation 8]

Q(x(t))=x^{T}(t)(I−PP^{T})x(t) (8)

Next, similarly, the univariate T\hat{ }2 statistic calculation unit 62 obtains the m univariate T\hat{ }2 statistics. The formula for calculating the T\hat{ }2 statistic is generally given by the following formula. Hotelling T\hat{ }2 statistic:

[Equation 9]

T²(x(t))=x^{T}(t)P^{T}λ⁻¹Px(t) (9)

Equation (9) is applied to obtain the univariate T\hat{ }2 statistic simply for one variable. The loading matrix P=1 for one variable, and the dispersion in the principal component direction has only the first principal component, so that it is the variance itself of the variable and is the normalized variable itself represented by Equation (1). Therefore, the univariate T\hat{ }2 statistic calculation unit 62 synonymously executes the normalization process of Equation (1) on the on-line data. These are the actions of the statistic calculation unit 261.

Next, the bivariate Q statistic and the univariate T\hat{ }2 statistic are synthesized to define the contribution amount for each variable.

The simplest but most straightforward definition is a method to define “the total m statistics of m−1 bivariate Q statistics for a variable k and a univariate T\hat{ }2 statistic for the variable k” as the contribution amount of variable k. By performing definition in this way, the contribution amount of the variable k can have a feature in which “when a certain variable k itself shows some anomaly sign, or when the relationship between the variable k and the related (correlated) variable is greatly broken”, “the contribution amount of the variable k become large”.

As another way to perform definition, it is also possible to define “the maximum value of the total m statistics of m−1 bivariate Q statistics for a variable k and a univariate T\hat{ }2 statistic for the variable k” as the contribution amount of the variable k. By performing definition in this way, the contribution amount of the variable k can have a feature in which “when a certain variable k itself shows some anomaly sign, or when one or a plurality of the relationships between the variable k and the related (correlated) variable is broken”, “the contribution amount of the variable k become large”.

Normally, it is preferable to define the contribution amount of the variable k by one of the above methods, but depending on the purpose, another definition may be made using the bivariate Q statistic and the univariate T\hat{ }2 statistic for the variable k. For example, since the univariate T\hat{ }2 statistic is essentially the same as process monitoring by the normal SPC, as mentioned above, when it is not desired to incorporate the monitoring/detection of events that have already been monitored by the SPC into the monitoring system of the present invention, it is possible to perform definition using only the bivariate Q statistic. When specializing in the purpose of detecting anomaly signs that cannot be detected by the SPC, it is preferable to define the contribution amount of the variable k by excluding the univariate T\hat{ }2 statistic. On the other hand, when it is desired to detect an anomaly including an anomaly that is detected by the SPC in the anomaly sign monitoring/diagnosis system of the present embodiment, it is better to include the univariate T\hat{ }2 statistic.

In this way, there is a degree of freedom in defining the contribution amount in the contribution amount calculation unit 262. The contribution amount can be flexibly defined after deciding in advance what kind of anomaly is desired to be detected by using this degree of freedom. This is one of the important features of this embodiment, and is a function that can never be realized with a conventional MSPC, which is a drill-down approach. By performing definition in a build-up manner as in the embodiment, it is possible to construct a diagnostic system with a clearer purpose.

Another important point is that when the combination of input variables is changed from use of all variables m to use of some selected variables p<m, the contribution amount can be defined by performing the above operation only on the selected variable without changing the definition of the contribution amount. This point is one of the most important points of the present embodiment. Taking the approach of stacking portion (parts) almost eliminates the need to reconstruct the diagnosis model due to a change in the combination of input variables, and it is possible to realize the diagnostic system by calculating only the variables that it is desired to consider when simply calculating the statistic and the contribution amount. The above is the action of the contribution amount calculation unit 262.

Next, the comprehensive statistic calculation unit 263 calculates a comprehensive statistic S for monitoring the entire plant from the contribution amount for each variable calculated by the contribution amount calculation unit 262. There is a great deal of degrees of freedom in defining this comprehensive statistic S.

The most straightforward and natural way to define the comprehensive statistic S is to use the sum of the contribution amounts of respective variables calculated by the contribution amount calculation unit 262 as the comprehensive statistic S. This is the most natural and consistent with a traditional MSPC thinking. With the conventional MSPC, the Q statistic and T\hat{ }2 statistic are calculated first, and the contribution amount is defined in the form of decomposing the statistics. On the contrary, in the embodiment, the contribution amount is defined first, and then the comprehensive statistic S is defined by taking the sum of them. From the point of view of the operator who monitors the plant, there is no difference between the MSPC and the monitoring method of the present embodiment in that the contribution amount is obtained by decomposing the comprehensive statistic. Therefore, it is possible to construct a system in the same way as the MSPC in appearance, but practically, statistics are defined by accumulating the contribution amount, so that, as mentioned earlier, it is easy to clarify the purpose of diagnosis.

When the contribution amount calculation unit 262 defines the statistic of each variable as the sum of the bivariate Q statistic and the univariate T\hat{ }2 statistic, the comprehensive statistic S defined here is the same as the value obtained by calculating the sum of all bivariate Q statistics and univariate T\hat{ }2 statistics as a result. Therefore, in essence, the contribution amount calculation unit 262 is not required, but as will be described later, when tracing (estimating) the factor at the time of anomaly sign detection in reverse, calculating the contribution amount for each variable is useful for understanding, and even when the contribution amount defined and calculated by the contribution amount calculation unit 262 is not defined by the sum total, there is a merit in which it is possible to define the comprehensive statistic S so as to be consistent with MSPC, so that the contribution amount calculation unit 262 calculates the contribution amount.

In addition, there is a degree of freedom in the definition method of the comprehensive statistic S, and as in the case of the contribution amount calculation unit 262, the definition that “the maximum value in the contribution amount of each variable is set as the comprehensive statistic” can be used. Using this definition breaks the relationship of “the statistic=the sum of the contribution amounts” guaranteed by the conventional MSPC, but for example, when the same definition is used for the contribution amount of the contribution amount calculation unit 262, as a result, the anomaly sign is detected by the comprehensive statistic when an anomaly sign is found in any one or a plurality of the bivariate Q statistic and the univariate T\hat{ }2 statistic. In other words, when an anomaly sign is an anomaly sign that can be detected by the bivariate Q statistic or the univariate T\hat{ }2 statistic, it is possible to realize extremely sensitive anomaly sign monitoring/diagnosis that can detect the sign without fail. Normally, since such an anomaly sign monitoring/diagnosis is likely to have too high detection sensitivity and a tendency for alarms to be issued frequently, in general, it is highly likely that it is not preferable to construct a system by defining comprehensive statistic in this way. However, it should be noted that, for example, in a case where the detection sensitivity of anomaly signs is not high enough when the comprehensive statistic S is defined by the sum of the contribution amounts, the anomaly sign monitoring/diagnosis system with higher detection sensitivity is realized simply by changing the definition of the comprehensive statistic S in this way, with the way of monitoring unchanged from the user's point of view.

As described above, the function of calculating one comprehensive statistic from the contribution amount of the m variables based on the sum of the contribution amounts and the maximum value is the action of the comprehensive statistic calculation unit 263.

The comprehensive statistic S calculated as described above may be used for plant monitoring as it is, but when it is realized as an anomaly sign diagnosis system that performs an anomaly detection and a factor estimation, it is preferable to perform the normalization process shown below. That is, the comprehensive statistic Sn calculated by the comprehensive statistic calculation unit 263 is divided by the threshold of the comprehensive statistic S calculated by the statistic threshold calculation unit 233 to calculate the normalized comprehensive statistic Sn. When the comprehensive statistic is defined by the sum of the contribution amount, it is normalized by dividing the comprehensive statistic Sn by the threshold of the comprehensive statistic S defined in the above Equation (7). When the comprehensive statistic is defined by the maximum value of the contribution amount, and the contribution amount is defined by the maximum value of the bivariate Q statistic and the univariate T\hat{ }2 statistic, it is preferable to normalize the comprehensive statistic S using the threshold in Equation (5) or Equation (6).

Also, when a combination in which the contribution amount of each variable is defined by the sum of the bivariate Q statistic and the univariate T\hat{ }2 statistic, and the maximum value of the contribution amount of each variable is defined as the comprehensive statistic S is used, the threshold corresponding to Equation (7) for the contribution amount defined by the summation may be calculated to perform the normalization process, and the maximum value may be defined as the normalized comprehensive statistic.

Since the only essential difference between Equations (6) and Equation (7) is the difference in the degree of freedom, the threshold is adjusted by considering the defined comprehensive statistic S is a statistic with what kind of degree of freedom to divide it by the threshold, and finally, the normalized statistic with the threshold=1 is calculated.

Also, since when the combination of input variables is changed significantly, the degree of freedom of the comprehensive statistic S can also change, the normalized comprehensive statistic calculation unit 264 may perform calculation in real time after determining the degree of freedom instead of calculating the threshold of the comprehensive statistic calculated by the statistic threshold calculation unit 233 in advance. However, since it is considered that when adding or deleting some input variables for the combination of predetermined input variables, there is no significant change in the degree of freedom, no problem seems to occur practically even when the comprehensive statistic threshold calculated in advance by the statistic threshold calculation unit 233 is applied as it is.

By dividing the comprehensive statistic by the threshold of the comprehensive statistic in this way, the normalized statistic Sn that determines the anomaly sign by the threshold 1 is calculated. When calculating the normalized statistic Sn, the contribution amount to it, and the bivariate Q statistic and the univariate T\hat{ }2 statistic that generates the contribution amount must also be normalized with the value same as that of the threshold used for the comprehensive statistic.

Although such normalization is important in plant monitoring using statistic that has no physical meaning, an index with 1 as a threshold is not always preferable. In the normalized comprehensive statistic Sn, it is considered abnormal when Sn exceeds one, but since the excess amount can rise in any values, the normalized statistic Sn defined in this way may be an excessive value such as 100 or more for example, when an excessive value is mixed in the plant monitoring data due to a transmission error or replacement of a missing value. When such an excessive value is taken, it is considered that it occurs often due to the influence of outliers such as transmission errors, and, normally, a state where the value is about five or more with respect to the threshold one is a certain abnormal state, and identifying and monitoring values higher than these values is not necessarily preferable. Specifically, when monitoring time series data of the statistic by a method called a trend graph or the like, it is easier to display on the trend graph, etc. used for plant monitoring when the upper and lower limits of the comprehensive statistic are clearly determined, and it is easy for the plant administrator who is the user to understand the display. Therefore, the statistic whose threshold is normalized by one can be replaced with a normalization index that has a value of 0 to 1 (0% to 100%), for example. In this case, a non-linear transformation as defined by Equation (10) is further performed on the comprehensive statistic whose threshold is normalized by one.

[Equation 10]

SN(x(t))=1−exp(−log(2)×Sn(x(t))) (10)

SN is a new normalized comprehensive statistic obtained by non-linearly transforming the normalized comprehensive statistic Sn by Equation (10), and is a statistic that takes a value from 0 to 1 and constrains the range so that SN=0 when Sn=0 and SN=1 when Sn=infinity. Further, since SN=0.5 when Sn=1, when SN is set as the normalized comprehensive statistic, it is an anomaly index such that the threshold is 0.5 when complete normal=0 and complete anomaly=1. Note that since Equation (10), which defines SN, is a non-linear transformation, when the same conversion as in Equation (10) is performed on the contribution amount to Sn, the relational expression that “the comprehensive statistic=the sum of the contribution amounts” cannot be maintained. Therefore, the contribution amount to the normalized comprehensive statistic SN is redefined by the following equation.

[Equation 11]

SN contribution amount of variable k=SN×Contribution amount of k to Sn÷Sn (11)

By redefining the value obtained by distributing the normalized comprehensive statistic SN by the contribution of the normalized comprehensive statistic Sn before transformation as the contribution of the variable k to the SN, the relational expression that “the comprehensive statistic=the sum of the contributions” can be maintained. The above is the action of the normalized comprehensive statistic calculation unit 264.

Next, the anomaly determination unit 265 makes an anomaly determination using the normalized statistic Sn or SN. Since this process is simple and the comprehensive statistic has already been normalized, when Sn is used, the presence or absence of an anomaly is determined by whether Sn exceeds one. When SN is used, the presence or absence of an anomaly is determined by whether SN exceeds the threshold of 0.5. Of course, since noise can be mixed in the time series data, for example, “when the threshold one (or 0.5) is exceeded for a certain period of time or longer” can be set as the criterion of the anomaly determination. Also, the case when the percentage at which the threshold one is exceeded during a predetermined period is large can be set as the criterion of the anomaly determination.

In any case, given a criterion by which whether to issue an anomaly report is determined based on the value of the comprehensive statistic Sn or SN normalized in this way, the anomaly determination unit 265 makes the determination of the presence or absence of the anomaly based on this criterion. This is the action of the anomaly determination unit 265.

Next, when there are any signs of an anomaly in the normalized comprehensive statistic SN, the upper factor estimation unit 266 sorts the contributions to SN in descending order (decreasing order), and extracts the contributions of the upper L variables with a large contribution as a variable that can be a factor candidate at the time of the anomaly sign. Here, L is a parameter determined by the designer, and is usually set to about 3 to 10. Alternatively, a threshold ThC may be set for the contribution, and variables exceeding ThC may be extracted as factor candidate variables.

The function of estimating the upper factor based on the contribution to the SN in this way is the action of the upper factor estimation unit 266, and this action is the same as that performed by the conventional MSPC.

The above is the action of the on-line anomaly monitoring/diagnosis unit 26.

Next, the user interface unit 28 displays the various pieces of information calculated by the on-line anomaly monitoring/diagnosis unit 26 and the on-line process data extracted by the on-line anomaly diagnosis data extraction unit 222 on the display unit 281 as appropriate monitoring information through a monitoring screen of the SCADA when the process monitoring device 2 is constructed on the monitoring control system (SCADA), or through a monitoring screen that can be monitored with a web browser, etc. when it is implemented on the cloud. The user can monitor the monitoring information displayed on the display unit 281. Various methods can be considered as this monitoring form.

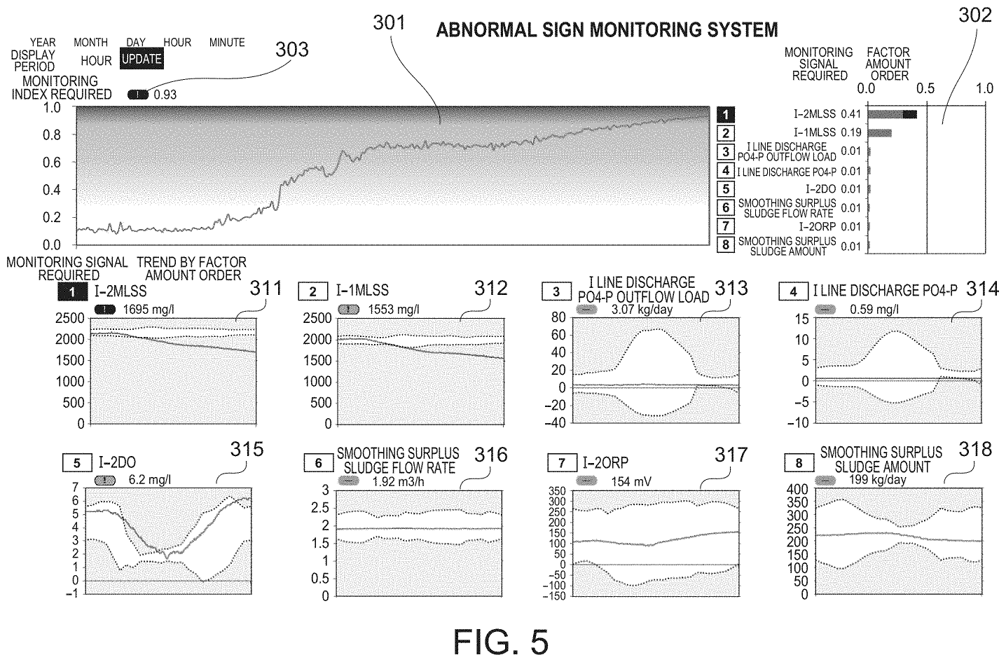

FIG. 5 is a diagram showing an example of a monitoring screen displayed on the display unit 281 of the process monitoring device 2 according to the embodiment. A trend graph 301 shown in FIG. 5 is a trend graph of the normalized comprehensive statistic SN. As shown in FIG. 5, the normalized comprehensive statistic SN has a value in the range of 0 to 1, and is a trend graph in which it can be determined that an anomaly sign appears when the threshold exceeds 0.5 in the display range. In FIG. 5, it can be seen that the situation is changing from a normal state to an abnormal state. A bar graph 302 shown in FIG. 5 is a bar graph called a contribution plot, in which the upper eight factors of contribution to the normalized comprehensive statistic are plotted. From this bar graph, it can be visually determined that the upper two variables (MLSS) are suspicious as factors of anomaly signs. Eight trend graphs 311 to 318 shown in FIG. 5 show the trend graphs for the variables estimated to be the factors of the upper anomaly signs displayed in the contribution plot, including the normal fluctuation range of each trend graph. From the trend graphs 311 to 318 shown in FIG. 5, it can be seen that the upper two factor variables (MLSS) have a large downward trend.

The monitoring information display method shown in FIG. 5 is a monitoring method in which a threshold for detecting an anomaly is set, and “diagnosis logic” may be added when performing diagnosis in addition to mere monitoring. For example, in FIG. 5, when the period in which the normalized comprehensive statistic exceeds 0.5 continues for a predetermined time or longer, an alarm indicating that it is abnormal is issued on the display screen, by text, by voice, by email, or the like. In FIG. 5, a warning display 303 is provided. Such a warning display 303 and in addition, a message such as “an anomaly signs is recognized” can be displayed on the screen, or can be delivered by e-mail to a remote operator. It is also possible to make an alarm sound by voice at the same time. For example, as shown in FIG. 5, it is possible to clearly show where the anomaly is occurring by displaying the screen in yellow, etc. so that the upper anomaly factors can be clearly seen when the contribution exceeds a predetermined threshold (for example, 0.3=30%), and it is possible to “diagnose” a sign of an anomaly value by displaying and distributing this information by text, voice, email, etc.

The monitoring method shown in FIG. 5 is exactly the same as the conventional MSPC monitoring method from the viewpoint of plant monitoring. That is, in the present embodiment, the monitoring method can be apparently the same as that of the conventional MSPC.

In the embodiment, plant monitoring can be performed by a monitoring method that is apparently the same as that of the MSPC. The present embodiment exerts a great effect in the following cases.

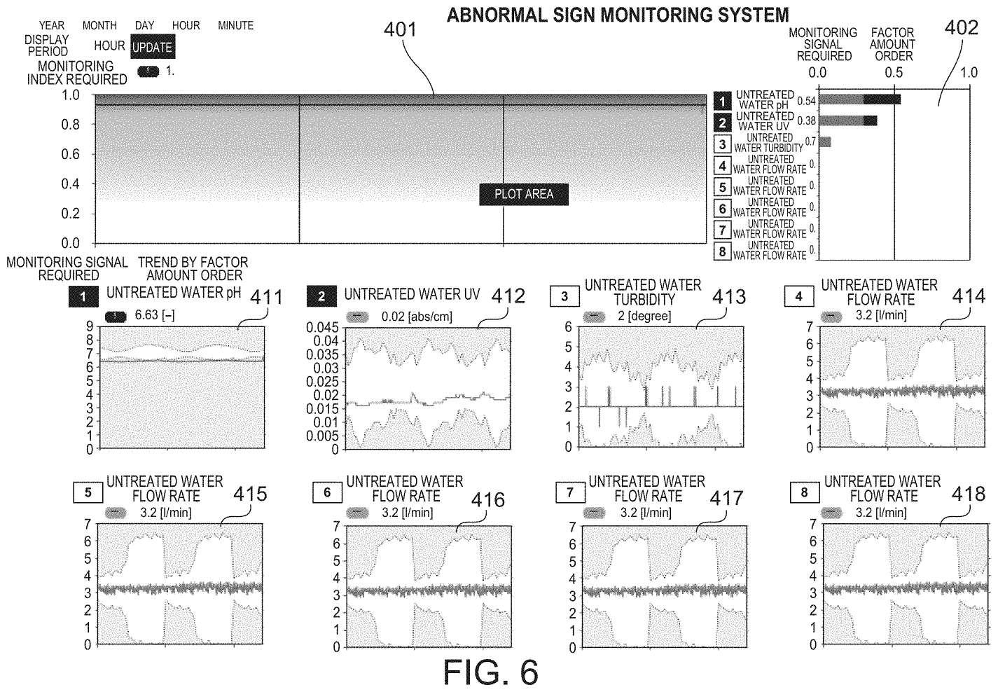

FIG. 6 is a diagram showing an example of a monitoring screen displayed on the display unit 281 of the process monitoring device 2 according to the embodiment. The monitoring image shown in FIG. 6 shows monitoring of the plant, which is the same monitoring method as in FIG. 5. As shown in FIG. 6, the normalized comprehensive statistic SN of a trend graph 401 is almost stuck to the upper limit value of one, and is in a completely abnormal state. The cause of this is that the pH value estimated as the first factor of the anomaly sign is in an abnormal state, and the true cause of this is the failure of the pH meter. In such a case, because the pH meter is out of order, it is a correct determination that the normalized statistic SN is almost one, but once the cause is found to be the pH meter failure, it is not necessary to constantly monitor and diagnose it. Rather, it is difficult to monitor a sign of an anomaly other than the pH meter failure. Of course, when another anomaly occurs, it is expected that the factor variable of the anomaly will rise in the upper factor of the contribution plot, but since the normalized comprehensive statistic SN is located constantly around one, the plant operator is less likely to notice the change when a new anomaly sign appear. In such a case, in the conventional MSPC, it is necessary to exclude the information of the sensor that has failed from the input variable until the failure is recovered, and to construct the anomaly diagnosis model again. Alternatively, by predetermining a default value (standard value) for the failed sensor and replacing a value with the default value, it is necessary to perform monitoring while temporarily suppressing the influence of the information of the failure sensor (masking process). However, this is just a first aid measure. This embodiment is particularly effective in such cases. When it is desired to exclude the pH meter information from the input variables, there is no need to make any corrections of the anomaly diagnosis model automatic construction unit 23. In the on-line anomaly monitoring/diagnosis unit 26, when calculating the bivariate Q statistic and the univariate T\hat{ }2 statistic, it is only required to exclude the information about the pH meter. Strictly speaking, the threshold of the comprehensive statistic SN may also change, but usually, changing a few input variables does not require recalculation of the threshold. In the embodiment, when the combination of input variables is changed in this way, there is a peculiar effect that the change can be significantly easily handled, compared with the conventional MSPC.

In addition, unlike the conventional MSPC, it has small building blocks as partial information, so that the monitoring form itself can be arranged, and it is possible to make the monitoring form easier to understand.

It is also possible to use a monitoring method in which the information itself of the bivariate Q statistic and the univariate T\hat{ }2 statistic is set as a factor when the comprehensive statistic is abnormal. In this case, instead of the monitoring form shown in FIG. 5 and FIG. 6, as a factor estimation, it is estimated that “a specific variable k is a factor (univariate T\hat{ }2 statistic anomaly)”, or it is estimated that “the break of the correlation between one variable X and another variable Y is a factor (bivariate Q statistic anomaly)”. In this case, the bar graph 302 of the contribution plot shown in FIG. 5 and the bar graph 402 of the contribution plot shown in FIG. 6 are monitored as the value of the (normalized) bivariate Q statistic or the univariate T\hat{ }2 statistic.

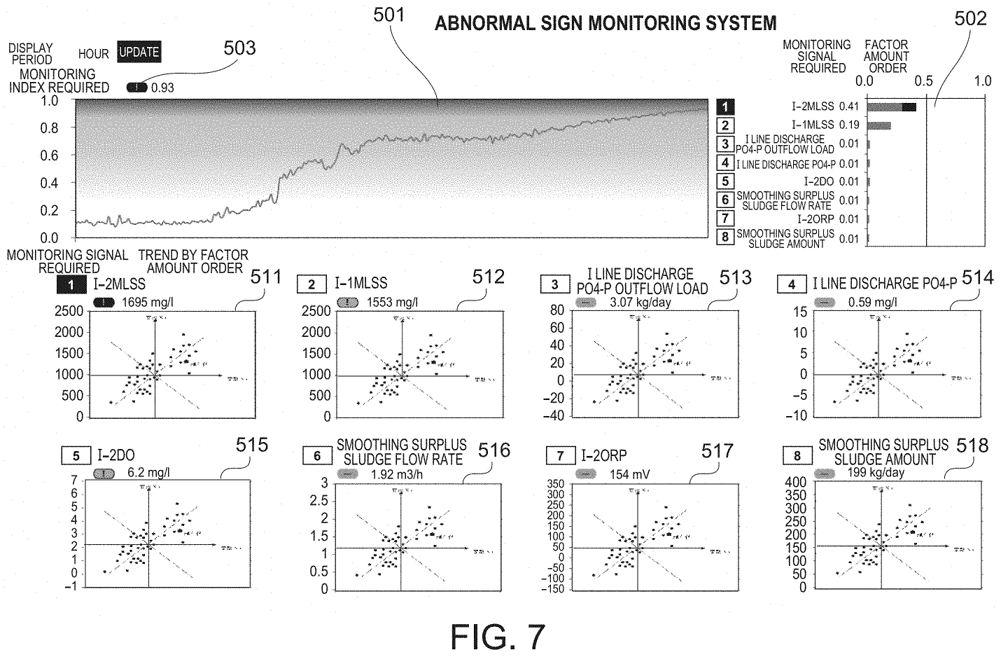

FIG. 7 is a diagram showing an example of a monitoring screen displayed on the display unit 281 of the process monitoring device 2 according to the embodiment. When observing the break of the relationship between the two variables, the trend graphs 311 to 318 of the upper factors shown in FIG. 5 and the trend graphs 411 to 418 of the upper factors shown in FIG. 6 are indicated by the bivariate scatter plots 511 to 518 as shown in FIG. 7, making it possible to recognize the position of the data at the time of monitoring.

When the factor appears in the univariate T\hat{ }2 statistic, the trend graph of the variable may be displayed, but in order to match the expression with the case where the bivariate Q statistic is the factor, the corresponding variable k may be displayed as a position on a straight line of 45 degrees on both the horizontal axis and the vertical axis.

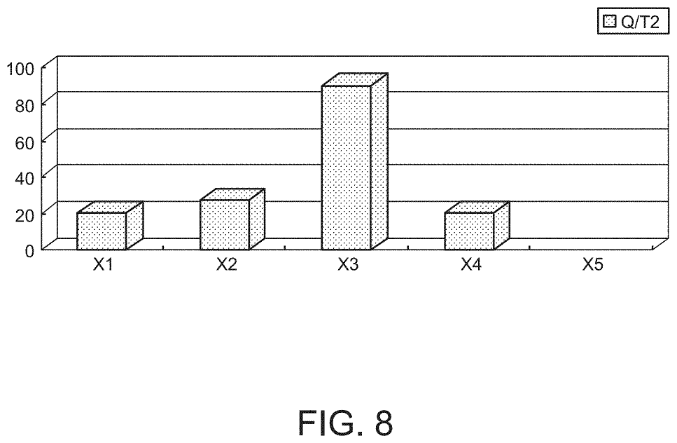

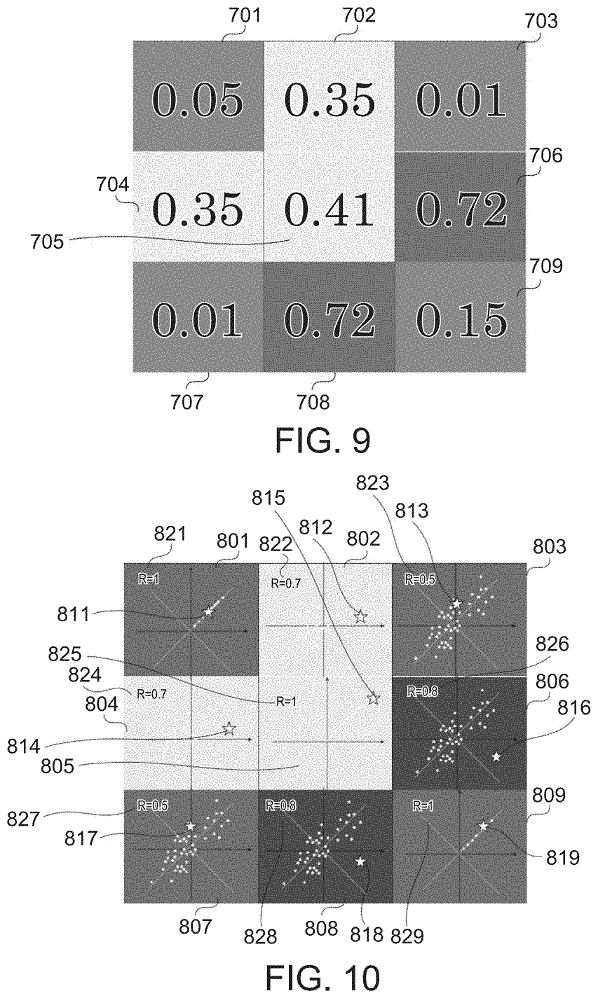

Furthermore, it is also possible to use a monitoring form in which the contribution of the statistic to the comprehensive statistic output by the comprehensive statistic calculation unit 263, and the contribution related to the T\hat{ }2 statistic to the statistic and the Q statistic of the variable and another variable are displayed on the display unit 281. In this case, first, the anomaly factor is estimated for each variable k on the monitoring screen as shown in FIGS. 5 and 6. Up to this point, the monitoring is the same as the conventional MSPC monitoring. In the contribution plot bar graph 302 shown in FIG. 5 and the contribution plot bar graph 402 shown in FIG. 6, when clicking on the bar of a variable (let's say X) that is likely to be a factor (cause), a graph as shown in FIG. 8 or FIG. 9 is displayed.

FIG. 8 is a bar graph of the normalized bivariate Q statistic and the normalized univariate T\hat{ }2 statistic related to the variable X displayed on the display unit 281 of the process monitoring device 2 according to the embodiment. The bar graph shown in FIG. 8 is the contribution to the variable k, which is an upper factor with a high contribution, and the factors are drilled down. In other words, the structure is such that in case of any anomaly, it is estimated that the variable related to the anomaly is X to further estimate that the reason why X is a factor is whether X itself is abnormal or the relationship with Y related to X is abnormal. In FIG. 8, each bar shows univariate T\hat{ }2 statistic or bivariate Q statistic, and bars of univariate T\hat{ }2 statistic and bivariate Q statistic respectively relating to the variable X are arranged.

FIG. 9 is a diagram showing the values of the bivariate Q statistic and the univariate T\hat{ }2 statistic together with the concentration display displayed on the display unit 281 of the process monitoring device 2 according to the embodiment. As shown in FIG. 9, instead of looking only at a certain variable with the upper factor, a group of variables that are highly correlated with the variable is extracted, and the values of the bivariate Q statistic and the univariate T\hat{ }2 statistic related to these variables are shown together with the density (color) display. In this case, there are two variables that are highly correlated with X (let's say Y and Z), and the values of the (normalized) bivariate Q statistic and univariate T\hat{ }2 statistic related to X, Y, and Z are shown. As shown in FIG. 9, the univariate T\hat{ }2 statistic 701 of X, the bivariate Q statistics 702 and 704 of X and Y, the bivariate Q statistics 703 and 707 of X and Z, the univariate T\hat{ }2 statistic 705 of Y, the bivariate Q statistics 706 and 708 of Y and Z, and the univariate T\hat{ }2 statistic 709 of Z are displayed on the display unit 281. In the case of this example, it can be estimated that that the relationship between Y and Z is greatly broken is the factor, and that is probably caused by Y. By displaying such a two-dimensional display, it is possible to make it easier to estimate the factor of the anomaly.

FIG. 10 is a diagram showing a matrix scatter plot and a current value for a combination of two variables having a high correlation with the upper estimation factor displayed on the display unit 281 of the process monitoring device 2 according to the embodiment. As shown in FIG. 10, the simultaneous display of a matrix scatter plot and a correlation coefficient can be adopted as a display format. As shown in FIG. 10, a matrix scatter plot is drawn for the combination of two variables that are highly correlated with the upper estimation factors, and the current values 811 to 819 are shown in it. Furthermore, by displaying the correlation coefficients 821 to 829, it is possible to visually grasp how much correlation the variables have. The display shown in FIG. 10 may be used as a substitute for the display shown in FIG. 9, or may be a display form such that the displays shown in FIG. 9 and FIG. 10 can be switched.

As mentioned earlier, when the monitoring screen displayed on the display unit 281 is in the state shown in FIG. 7, or when it is desired to add/delete variables at the discretion of the plant operator who is the user the input variable selection unit 29 can display the screen for selecting variables on the display unit 281, and switch the combination of input variables as appropriate.

In addition, originally, in multivariate plant monitoring, it is better to monitor as many variables as possible at once unless variables that are influential, such as outliers, affect overall monitoring, so that a monitoring form in which automatic selection of input variables is added may be used so that the combination of the default (maximum number of) input variables is determined, the variable is automatically deleted when the contribution of a particular variable continues to be high for a period of time, and monitoring is performed with a combination of the maximum number of input variables as long as it does not fall into the state shown in FIG. 7.

As described above, the configuration of the present embodiment makes it possible to achieve a build-up type monitoring form in which building blocks are stacked. As a result, not only a flexible monitoring system can be constructed according to the purpose, but also the method of estimating a factor can be arranged, and the true factor can be estimated more easily.

In addition, the present embodiment provide a process monitoring device, a process monitoring method, and a program capable of excluding/adding data acquired by a specific sensor from a monitored/diagnosed target without reconstructing a diagnosis model.

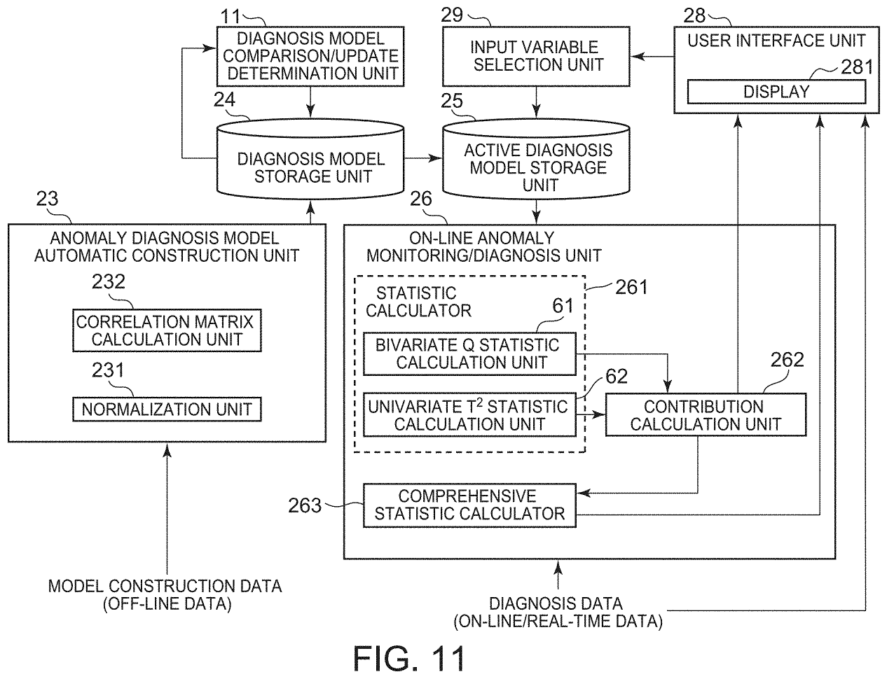

FIG. 11 is a diagram showing a configuration of a modification of the process monitoring device 2 according to the embodiment. As shown in FIG. 11, the process monitoring device 2 according to the embodiment may have a configuration excluding the statistic threshold calculation unit 233, the normalized comprehensive statistic calculation unit 264, the anomaly determination unit 265, and the upper factor estimation unit 266.

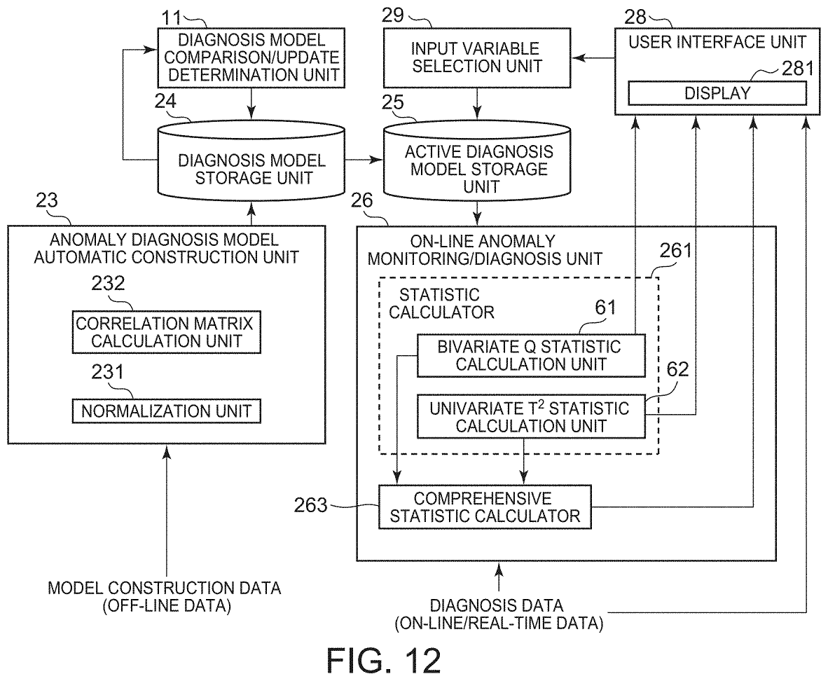

FIG. 12 is a diagram showing a configuration of another modification of the process monitoring device 2 according to the embodiment. As shown in FIG. 12, the process monitoring device 2 according to the embodiment may have a configuration further excluding the contribution calculation unit 262.

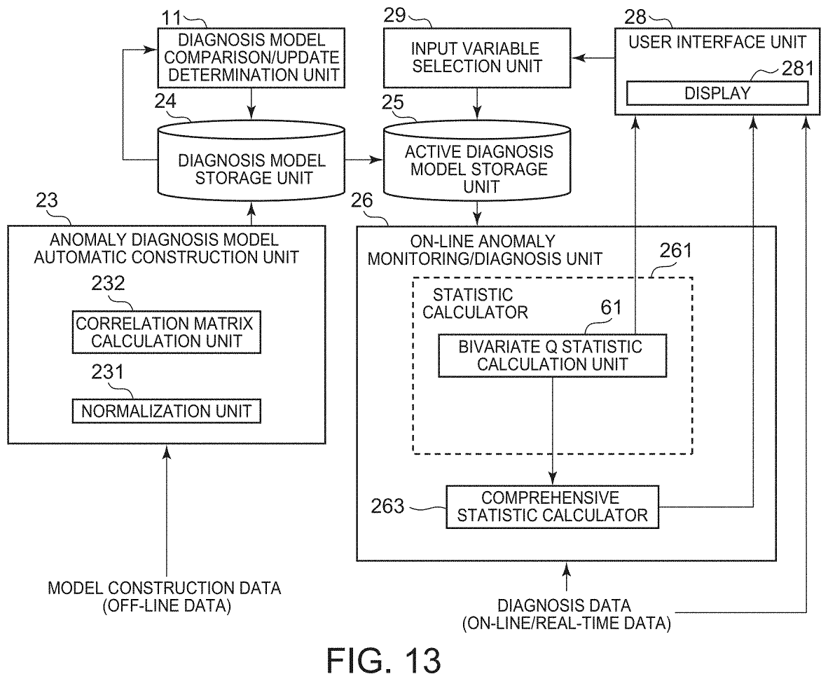

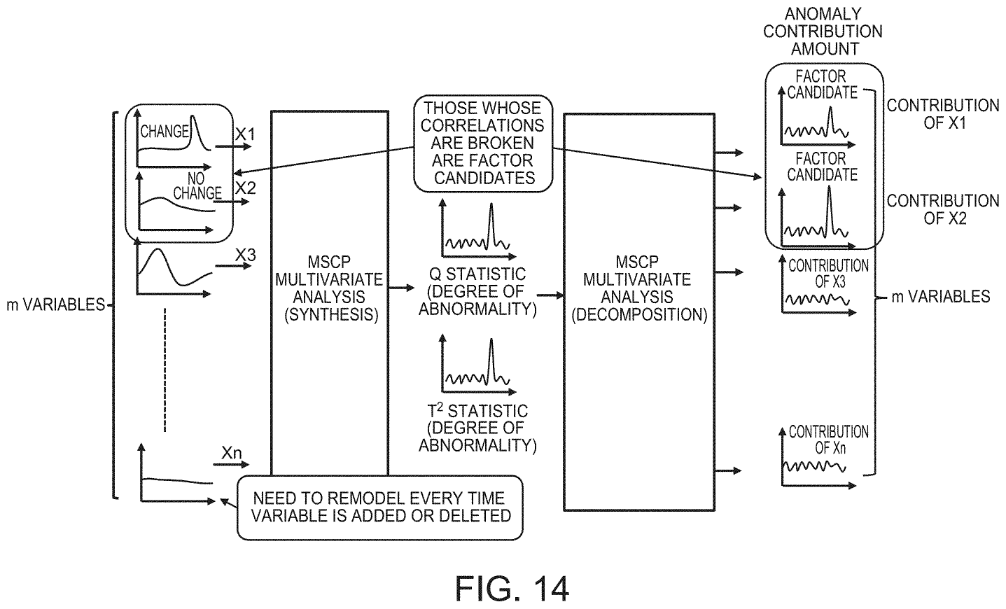

FIG. 13 is a diagram showing a configuration of still another modification of the process monitoring device 2 according to the embodiment. As shown in FIG. 13, the process monitoring device 2 according to the embodiment may have a configuration further excluding the univariate T\hat{ }2 statistic calculation unit 62.

The modifications of the present embodiment shown in FIGS. 11 to 13 can be realized as a system that simply provides plant monitoring information without performing diagnosis. In other words, in a case of using the bivariate Q statistic and the univariate T\hat{ }2 statistic, when all combinations of them are calculated, it is possible to construct a monitoring system simply by integrating them. Further, since it is not always necessary to perform the normalization process based on the threshold, the threshold calculation process may be omitted.

Part or all of the above embodiments may also be described as in, but not limited to, the following appendixes.

(Appendix 1) In any process having at least m (m≥2) process sensors capable of measuring a state quantity and an operation quantity of a target process in a predetermined cycle, a modular type anomaly sign monitoring device having a data collection/storage function of collecting and storing time series data of a plurality of (m) process variables measured by the process sensors at a predetermined cycle, a data extraction function of extracting data for a predetermined period from the data collection/storage function, a bivariate Q statistic calculation function of calculating, by a multivariate statistical process control (MSPC) method, a Q statistic of two-variable data of all m_C_2 combinations of two process variables out of m process variables for time series data of a plurality of (m) process variables extracted by the data extraction function, a comprehensive statistic calculation function of calculating a comprehensive statistic, which is anomaly detection data of p variables, by the sum of the p_C_2 bivariate Q statistics related to the p (p≤m) variables specified from the m variables, a comprehensive statistic monitoring function of calculating and monitoring a bivariate Q statistic and a comprehensive statistic based on it from on-line measurement data of the p variables in the m variables measured on-line at a predetermined cycle, and a comprehensive statistic contribution monitoring function of calculating the ratio of the contribution of the bivariate Q statistic to the comprehensive statistic monitoring function and calculating and monitoring the contribution of the p_C_2 combinations of two variables.

(Appendix 2) In the embodiment described in Appendix 1, the modular type anomaly sign monitoring device having a function of calculating a univariate T2 statistic of m variables in addition to the bivariate Q statistic calculation function, a comprehensive statistic calculation function modified to calculate a comprehensive statistic, which is anomaly detection data of the p variables, by the sum of the (p+p_C_2) statistics of the p_C_2 bivariate Q statistics and the p univariate T\hat{ }2 statistics related to the p (p≤m) variables in the comprehensive statistic calculation function, a comprehensive statistic monitoring function of calculating and monitoring the bivariate Q statistic and the univariate T\hat{ }2 statistic, and comprehensive statistic based on them from the on-line measurement data of the p variables in the m variables measured on-line at a predetermined cycle, a comprehensive statistic contribution monitoring function of calculating the ratio of the contribution of the bivariate Q statistic and the univariate T\hat{ }2 statistic to the comprehensive statistic monitoring function, and calculating and monitoring the contribution of the p_C_2 combinations of two variables and the p variables.

(Appendix 3) In the embodiment described in Appendix 1 or Appendix 2, the modular type anomaly sign monitoring device defining the comprehensive statistic not by the sum of the bivariate Q statistic and one univariate T\hat{ }2 statistic (when the univariate T\hat{ }2 statistic is defined), but by the maximum value of the statistics.

(Appendix 4) In the embodiments described in Appendix 1 to Appendix 3, the modular type anomaly sign monitoring device, having a function of newly synthesizing and defining a contribution related to the variable k from each variable k, k=1, 2, 3, . . . of the comprehensive statistic contribution monitoring function, total p contributions related to k by the sum of P−1 bivariate Q statistics related to P, when T\hat{ }2 statistics is defined, one univariate T\hat{ }2 statistic, defining the comprehensive statistic by the sum of the contributions related to the newly defined variable k as the comprehensive statistic calculation function, and monitoring the comprehensive statistic and the contribution related to the variable k.

(Appendix 5) In addition to the embodiment described in Appendix 4, the modular type anomaly sign monitoring device monitoring in two stages, the comprehensive statistic and the contribution related to the variable k, and the contribution of the bivariate Q statistic and the T\hat{ }2 statistic that compose it.

(Appendix 6) In the embodiments described in Appendix 1 to Appendix 3 and Appendix 5, the modular type anomaly sign monitoring device, when displaying a contribution of the bivariate Q statistic, displaying a correlation coefficient between two variables and/or a matrix scatter plot between two variables, and the contribution at the same time.

(Appendix 7) In addition to the embodiments described in Appendix 1 to Appendix 6, the modular type anomaly sign monitoring device having a function of setting an anomaly detection threshold for the comprehensive statistic, normalizing the comprehensive statistic with the set anomaly detection threshold, and monitoring the normalized comprehensive statistic and the contribution.

(Appendix 8) In the embodiment described in Appendix 7, the modular type anomaly sign monitoring device monitoring the comprehensive statistic and the contribution normalized with initial input variables selected as an input variable as all m variables, when the contribution for a variable k continues to exceed a predetermined threshold, and the elapsed time exceeds a predetermined time specified in advance, automatically excluding the variable, and preferably presenting the excluded variable k on the monitoring screen.

Further, the embodiments include the followings.

A process monitoring device comprising:

a data collector configured to acquire two or more variables indicating a state of a monitored target;

a statistic calculator configured to output each of the statistics that select two from the acquired variables; and

a comprehensive statistic calculator configured to output a comprehensive statistic indicating a state of the monitored target based on a statistic output by the statistic calculator.

A process monitoring method comprising:

acquiring two or more variables indicating a state of a monitored target;

outputting each of the statistics that select two from the acquired variables; and

outputting a comprehensive statistic that indicate a state of the monitored target based on the output of the statistics.

A computer program comprising:

acquiring two or more variables indicating a state of a monitored target;

outputting each of the statistics that select two from the acquired variables; and

outputting a comprehensive statistic that indicate a state of the monitored target based on the output of the statistics.

A computer program product comprising a computer readable storage medium having program instructions embedded therewith, the program instructions executable by at least one processor to cause the at least one processor to:

acquiring two or more variables indicating a state of a monitored target;

outputting each of the statistics that select two from the acquired variables; and

outputting a comprehensive statistic that indicate a state of the monitored target based on the output of the statistics.

A computer-readable storage medium storing a program for causing a computer to execute a process comprising:

acquiring two or more variables indicating a state of a monitored target;

outputting each of the statistics that select two from the acquired variables; and

outputting a comprehensive statistic that indicate a state of the monitored target based on the output of the statistics.

While certain embodiments of the present invention have been described, these embodiments have been presented by way of example only, and are not intended to limit the scope of the invention. These novel embodiments can be implemented in various other forms, and various omissions, substitutions, and modifications can be made without departing from the scope of the invention. These embodiments and modifications thereof are included in the scope and the gist of the invention, and are included in the invention described in the claims and the equivalent scope thereof.

What is claimed is:

1. A process monitoring device comprising:
a data collector configured to acquire two or more variables indicating a state of a monitored target;
a statistic calculator configured to output each of the statistics that select two from the acquired variables; and
a comprehensive statistic calculator configured to output a comprehensive statistic indicating a state of the monitored target based on a statistic output by the statistic calculator.

2. The process monitoring device according to claim 1, wherein
the statistic calculator outputs a Q statistic as the statistic.

3. The process monitoring device according to claim 2, wherein
the statistic calculator further outputs a T\hat{ }2 statistic for each of the variables as the statistic.

4. The process monitoring device according to claim 3, wherein
the comprehensive statistic calculator regards a sum of a Q statistic and a T\hat{ }2 statistic output by the statistic calculator as the comprehensive statistic.

5. The process monitoring device according to claim 3, wherein
the comprehensive statistic calculator regards a maximum value of a Q statistic and a T\hat{ }2 statistic output by the statistic calculator as the comprehensive statistic.

6. The process monitoring device according to claim 3, wherein
the statistic calculator outputs a statistic based on the T\hat{ }2 statistic and a Q statistic of the variable and another variable for each of the variables, and wherein
the comprehensive statistic calculator outputs the comprehensive statistic based on a statistic, for each variable, output by the statistic calculator.

7. The process monitoring device according to claim 1 further comprising:
a display capable of displaying a comprehensive statistic output by the comprehensive statistic calculator.

8. The process monitoring device according to claim 7, wherein
the display is capable of displaying a contribution of the each statistic to a comprehensive statistic output by the comprehensive statistic calculator.

9. The process monitoring device according to claim 3, further comprising:
a display capable of displaying a contribution of the statistic to a comprehensive statistic output by the comprehensive statistic calculator, and contributions related to the T\hat{ }2 statistic for the statistic and a Q statistic of the variable and another variable.

10. The process monitoring device according to claim 8, wherein
the display is capable of displaying a contribution of the statistic to a comprehensive statistic output by the comprehensive statistic calculator using one or both of a correlation coefficient and a matrix scatter plot of two variables of the statistic.

11. The process monitoring device according to claim 7, further comprising:
a statistic threshold calculation section that sets a threshold of a comprehensive statistic output by the comprehensive statistic calculator, the threshold indicating that an anomaly has occurred to the monitored target, wherein
the display is capable of displaying the comprehensive statistic normalized by a threshold, of a comprehensive statistic, set by the statistic threshold calculation section.

12. The process monitoring device according to claim 11, wherein
the statistic threshold calculation section is further capable of setting a threshold of a contribution of the variable to the comprehensive statistic, and wherein
the display is capable of displaying remaining variables after removing the variables whose contribution exceeds the threshold of the contribution for a predetermined time or longer.

13. A process monitoring method comprising:
acquiring two or more variables indicating a state of a monitored target;
outputting each of the statistics that select two from the acquired variables; and
outputting a comprehensive statistic that indicate a state of the monitored target based on the output of the statistics.

14. A computer program product comprising a computer readable storage medium having program instructions embedded therewith, the program instructions executable by at least one processor to cause the at least one processor to:
acquiring two or more variables indicating a state of a monitored target;
outputting each of the statistics that select two from the acquired variables; and
outputting a comprehensive statistic that indicate a state of the monitored target based on the output of the statistics.
